(19) United States
(12) Patent Application Publication
(10) Pub. No.: US 2011/0176603 A1
(43) Pub. Date: Jul. 21, 2011

(54) METHOD FOR CARRYING META-DATA OVER DIGITAL VIDEO BROADCASTING-SATELLITE SECOND GENERATION (DVB-S2) STREAMS OVER THE PHYSICAL-LAYER FRAMING STRUCTURE

(75) Inventors: Michael Beeler, Jefferson, MD (US); Cris Mamaril, Mesa, AZ (US); Frederick Morris, Gathersburg, MD (US); Jeffery Harig, Mesa, AZ (US)

(73) Assignee: COMTECH EF DATA CORP., Tempe, AZ (US)

(21) Appl. No.: 13/077,101

(22) Filed: Mar. 31, 2011

Related U.S. Application Data
(63) Continuation-in-part of application No. 13/024,402, filed on Feb. 10, 2011.

(51) Int. Cl. H04N 7/26

(52) U.S. Cl. 375/240.02; 375/240.26; 375/240.27; 375/E07.2; 375/E07.126

(57) ABSTRACT

A method of inserting meta-data into a physical layer framing structure of a Digital Video Broadcast Satellite-Generation 2 (DVB-S2) comprising encoding meta-data and an original carrier signal using an encoder, the original carrier signal having a pilot sequence, replacing, by a meta-data insertion device, at least a portion of the pilot sequence with at least a portion of the meta-data to form a meta-pilot carrier signal, modulating, using a modulator, the meta-pilot carrier signal to form a modulated meta-pilot carrier signal, and transmitting, using a transmitting device, the modulated meta-pilot carrier signal. Additionally, the meta-data may be inserted by a meta-data insertion device into at least a portion of the XFECFRAME structure when dummy-PL Frames are available when VCM and ACM operation is used.

### CROSS REFERENCE TO RELATED APPLICATIONS

This document is a continuation-in-part application of pending U.S. patent application Ser. No. 13/024,402, entitled “Embedded Meta-Carrier with Spread Spectrum via Overlaid Carriers” to Beeler et al., which was filed on Feb. 10, 2011, the disclosure of which is incorporated entirely herein by this reference. This document also claims the benefit of the filing date of U.S. Provisional Patent Application No. 61/35,944, entitled “A Method for Carrying Meta-data over Digital Video Broadcasting-Satellite Second Generation (DVB-S2) Streams over the Physical-Layer Framing Structure” to Michael Beeler, et al., which was filed on Jun. 17, 2010, the disclosure of which is hereby incorporated entirely herein by this reference.

### BACKGROUND

1. Technical Field

Aspects of this document relate generally to telecommunication systems and techniques for transmitting data across a telecommunication channel.

2. Background Art

Since the introduction of electromagnetic (EM) transmission, a recurring problem continuing to challenge the industry is the rogue or improperly configured transmitted carrier also known as an “interferer.” The problem is most prevalent in the satellite industry, but the technology described in this disclosure is not limited to satellite transmission systems. The interfering carrier may be caused by failed equipment that results in the transmission equipment transmitting or sweeping the wrong spectral location or locations. In this event, this carrier is known as a “rogue carrier.” A second type of interferer is known as an improperly configured carrier. An improperly configured carrier is primarily due to human error. In many situations, the rogue or improperly configured carrier results in service disruption due to interference with a carrier assigned to operate in the same occupied bandwidth. Thus, a need exists for a method that provides the ability for someone skilled in the art, such as, for example, a satellite operator, interference monitoring service, federal or state agency, or private or commercial operator, to rapidly identify the source of the interfering carrier.

### SUMMARY

Implementations of a method of inserting meta-data into a physical layer framing structure of a Digital Video Broadcast Satellite-Generation 2 (DVB-S2), may comprise encoding meta-data and an original carrier signal using an encoder, the original carrier signal having a pilot sequence, replacing, by a meta-data insertion device, at least a portion of the pilot sequence with at least a portion of the meta-data to form a meta-pilot carrier signal, modulating, using a modulator, the meta-pilot carrier signal to form a modulated meta-pilot carrier signal, and transmitting, using a transmitting device, the modulated meta-pilot carrier signal.

Particular implementations may comprise one or more of the following features. Methods may further comprise determining whether pilots are enabled for a DVB-S2 prior to the replacing. The pilot sequence may comprise 36 symbols and occurs every 16 slots in the original carrier signal. The symbols may be defined as I=1/√2 and Q=1/√2. The meta-data may comprise information relating to at least one of a manufacturer, a serial number, a model number, a configuration, and an operating parameter of a transmitting device. Methods may further comprise encoding the meta-data using a Forward Error Correction (FEC) encoder. Methods may further comprise randomization scrambling of the modulated I and Q symbols after bit mapping of the symbols into constellations after replacing. Methods may further comprise receiving the meta-data from a user input. Replacing the at least a portion of the pilot sequence may comprise replacing using one of an internal processing device and an external processing device. Methods may further comprise determining the meta-data based on a configuration of the transmitting device and incorporating the meta-data insertion device in the modulator. Replacing may further comprise replacing in a physical framing module within the modulator. Methods may further comprise creating a redundancy of the meta-pilot carrier signal using a redundancy controller. The redundancy may be a one-to-one redundancy or an m- to n redundancy.

Implementations of a method of inserting meta-data into a physical layer framing structure of a Digital Video Broadcast Satellite-Generation 2 (DVB-S2), may comprise encoding meta-data and an original carrier signal using an encoder, determining whether a dummy XFECFRAME is required to be transmitted, replacing, by a meta-data insertion device, 36 unmodulated slots of data within the encoded original carrier signal when no dummy XFECFRAME is required to be transmitted to form a meta-XFECFRAME carrier signal, modulating, using a modulator, the meta-XFECFRAME carrier signal to form a modulated meta-XFECFRAME carrier signal, and transmitting, using a transmitting device, the modulated meta-XFECFRAME carrier signal.

Particular implementations may comprise one or more of the following features. The encoding and modulating may comprise encoding and modulating using Adaptive Coding and Modulation (ACM). The encoding and modulating may comprise encoding and modulating using Variable Coding and Modulation (VCM). The meta-data may comprise information relating to at least one of a manufacturer, a serial number, a model number, a configuration, and an operating parameter of a transmitting device. The replacing may further comprise injecting, by a meta-data insertion device, the meta-data into the dummy XFECFRAME prior to randomization scrambling of modulated I and Q symbols within the encoded original carrier signal and after bit mapping the symbols into constellations. Methods may further comprise receiving the meta-data from a user input. Replacing the unmodulated slots of data may further comprise replacing using one of an internal processing device and an external processing device. Methods may further comprise determining the meta-data based on a configuration of the transmitting device and incorporating the meta-data insertion device in the modulator. Replacing may comprise replacing within a physical framing module in the modulator. Methods may further comprise creating a redundancy of the meta-XFECFRAME carrier signal using a redundancy controller. The redundancy may be a one-to-one redundancy or an m-to-n redundancy.

Implementations of a method of extracting meta-data from a physical layer framing structure of a Digital Video Broadcast Satellite-Generation 2 (DVB-S2) by a receiving device may comprise receiving, by a receiving device, a meta-pilot carrier signal comprising meta-data and an original carrier signal, demodulating, using a demodulator, the meta-pilot carrier signal, decoding, using a decoder, the meta-pilot carrier signal, and extracting, using an extraction device, meta-data embedded within a pilot sequence of the original carrier signal upon recognition of a physical layer frame when the pilot sequence is enabled.

Particular implementations may comprise one or more of the following features. The pilot sequence may be extracted by the demodulator. The extraction device may be a physical layer header decoder and extracts a header of the original carrier signal. Methods may further comprise processing the meta-data when Forward Error Correction (FEC) is present using a FEC decoder. Methods may further comprise outputting the meta-data to a receiving device. Methods may further comprise outputting the meta-data to a display device. Methods may further comprise outputting the meta-data to a computing device.

Implementations of a method of extracting meta-data from a physical layer framing structure of a Digital Video Broadcast Satellite-Generation 2 (DVB-S2) by a receiving device may comprise receiving, by a receiving device, a meta-pilot carrier signal comprising meta-data and an original carrier signal, demodulating, using a demodulator, the meta-pilot carrier signal, decoding, using a decoder, the meta-pilot carrier signal, and extracting, using an extraction device, meta-data embedded within the original carrier signal upon recognition of a dummy physical layer frame, the meta-data having previously replaced unmodulated slots of data within the original carrier signal prior to transmission of the original carrier signal to the receiving device.

Particular implementations may comprise one or more of the following features. The demodulator may extract meta-data contained in a dummy XFECFRAME. The extraction device may be a physical layer header decoder. Methods may further comprise processing a dummy physical layer frame using Adaptive Coding and Modulation (ACM) or Variable Coding and Modulation (VCM). Methods may further comprise processing the meta-data when Forward Error Correction (FEC) is present using a FEC encoder. Methods may further comprise outputting the meta-data to a receiving device. Methods may further comprise outputting the meta-data to a display device. Methods may further comprise outputting the meta-data to a computing device.

Implementations of a system for inserting meta-data into a physical layer framing structure of a Digital Video Broadcast Satellite-Generation 2 (DVB-S2) may comprise an encoder configured to encode meta-data and an original carrier signal, the original carrier signal having a pilot sequence, a meta-data insertion device configured to replace at least a portion of the pilot sequence with at least a portion of the meta-data to form a meta-pilot carrier signal, a modulator configured to modulate the meta-pilot carrier signal to form a modulated meta-pilot carrier signal, and a transmitting device configured to transmit the modulated meta-pilot carrier signal.

Particular implementations may comprise one or more of the following features. The meta-data insertion device may be configured to determine whether pilots are enabled for a DVB-S2 prior to replacing the at least a portion of the pilot sequence. The pilot sequence may comprise 36 symbols and occurs every 16 slots in the original carrier signal. The symbols may be defined as I=1/√2 and Q=1/√2. The meta-data may comprise information relating to at least one of a manufacturer, serial number, model number, configuration, and an operating parameter of a transmitting device. Methods may further comprise a Forward Error Correction (FEC) encoder that encodes the meta-data. Systems may further comprise a bit mapper configured to map the I and Q symbols into constellations prior to replacement of the at least a portion of the pilot sequence and a scrambler configured to randomly scramble the modulated I and Q symbols after the at least a portion of the pilot sequence is replaced. The encoder may be configured to receive the meta-data through a user input. Systems may further comprise a processing device configured to replace the at least a portion of the pilot sequence with the at least a portion of the meta-data. The modulator may be configured to insert the meta-data into the pilot sequence of the original carrier after a determination of the meta-data based on the configuration of the transmitting device. The modulator may further comprise a physical framing module configured to replace the at least a portion of the pilot sequence with the at least a portion of the meta-data. Systems may further comprise redundancy controller configured to create a redundancy of the meta-pilot carrier signal. The redundancy may be a one-to-one redundancy or an m-to-n redundancy.

Implementations of a system for inserting meta-data into a physical layer framing structure of a Digital Video Broadcast Satellite-Generation 2 (DVB-S2) may comprise an encoder configured to encode meta-data and an original carrier signal, a meta-data insertion device configured to determine whether an XFECFRAME is required to be transmitted and to replace 36 unmodulated slots of data within the encoded original carrier signal with at least a portion of the meta-data when no XFECFRAME is required to be transmitted to form a meta-pilot carrier signal, a modulator configured to modulate the meta-pilot carrier signal to form a modulated meta-pilot carrier signal, and a transmitting device configured to transmit the modulated meta-pilot carrier signal.

Particular implementations may comprise one or more of the following features. The encoder and modulator may be configured to use an Adaptive Coding and Modulation (ACM) format. The encoder and modulator may be configured to use a Variable Coding and Modulation (VCM) format. The meta-data may comprise information relating to at least one of a manufacturer, serial number, model number, configuration, and an operating parameter of a transmitting device. Systems may further comprise a bit mapper configured to map I and Q symbols within the encoded original carrier signal into constellations prior to replacement of the at least a portion of the pilot sequence and a scrambler configured to randomly scramble the modulated I and Q symbols after the at least a portion of the meta-data is injected into a dummy physical layer frame. The encoder may be configured to receive the meta-data from a user input. Systems may further comprise a processing device configured to inject the meta-data. The meta-data may be determined based on the configuration of the transmitting device and wherein the modulator is configured to replace the 36 unmodulated slots with the meta-data. The modulator may further comprise a physical framing module configured to replace the unmodulated slots of data. Systems may further comprise a redundancy controller configured to create a redundancy of the meta-pilot carrier signal. The redundancy may be a one-to-one redundancy or an m-to-n redundancy.

Implementations of a system for extracting meta-data from a physical layer framing structure of a Digital Video Broadcast Satellite-Generation 2 (DVB-S2) by a receiving device may comprise a receiving device configured to receive a meta-pilot carrier signal comprising meta-data and an original carrier signal, a demodulator configured to demodulate the meta-pilot carrier signal, a decoder that decodes the meta-pilot carrier signal, and an extraction device configured to extract meta-data embedded within a pilot sequence of the original carrier signal upon recognition of a physical layer frame when the pilot sequence is enabled.

Particular implementations may comprise one or more of the following features. The demodulator may be further configured to extract the pilot sequence. The extraction device may be a physical layer header decoder and is configured to extract a header of the original carrier signal. The meta-data may be processed when Forward Error Correction (FEC) is present. Systems may further comprise a receiving device configured to receive an output of the meta-data. Systems may further comprise a display device configured to receive an output of the meta-data. Systems may further comprise a computing device configured to receive an output of the meta-data.

Implementations of a system of extracting meta-data from a physical layer framing structure of a Digital Video Broadcast Satellite-Generation 2 (DVB-S2) by a receiving device may comprise a receiving device configured to receive a meta-pilot carrier signal comprising meta-data and an original carrier signal, a demodulator configured to demodulate the meta-pilot carrier signal, a decoder that decodes the meta-pilot carrier signal, and an extraction device configured to extract meta-data embedded within the original carrier signal upon recognition of a dummy physical layer frame, the meta-data having previously replaced unmodulated slots of data within the original carrier signal prior to transmission of the original carrier signal to the receiving device.

Particular implementations may comprise one or more of the following features. The demodulator may be configured to extract meta-data contained in an XFECFRAME of a dummy physical layer frame. The extraction device may be a physical layer header decoder. Systems may further comprise a processor configured to processes a dummy physical layer frame using Adaptive Coding and Modulation (ACM) or Variable Coding and Modulation (VCM). The meta-data may be processed when Forward Error Correction (FEC) is present. Systems may further comprise a receiving device configured to receive an output of the meta-data. Systems may further comprise a display device configured to receive an output of the meta-data. Systems may further comprise a computing device configured to receive an output of the meta-data.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112, ¶ 6. Thus, the use of the words “function,” “means” or “step” in the Description, Drawings, or Claims is not intended to somehow indicate a desire to invoke the special provisions of 35 U.S.C. §112, ¶6, to define the invention. To the contrary, if the provisions of 35 U.S.C. §112, ¶6 are sought to be invoked to define the claimed disclosure, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. §112, ¶ 6. Moreover, even if the provisions of 35 U.S.C. §112, ¶6 are invoked to define the claimed disclosure, it is intended that the disclosure not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is depicts an implementation of a DVB-S2 satellite network with the capability to insert meta-data.

FIG. 2 is a block diagram of an implementation of an earth station transmission system using a DVB-S2 encoding/modulation device using the described method for carrying meta-data.

FIG. 3 is a block diagram of an implementation for insertion of meta-data in a DVB-S2 modulating device.

FIG. 4 is a block diagram an implementation of an airborne or space-based satellite relay/repeater.

FIG. 5 is a block diagram of an implementation of a remote satellite station using a DVB-S2 demodulation/decoding device with the described method for carrying meta-data.

FIG. 6 depicts a structure of a DVB-S2 XFECFRAME frame before bit interleaving as specified in the ETSI EN 302 307 specification.

FIG. 7 depicts a structure of a DVB-S2 PL frame prior to scrambling as specified in the ETSI EN 302 307 specification.

FIG. 8 is a block diagram of the prior art showing a DVB-S2 receiver without meta-data.

FIG. 9 is a block diagram of an implementation of a method using a DVB-S2 receiver with meta-data.

FIGS. 10A-D are block diagrams of various redundancy configurations for a modulating device with support for the embedding of meta-data.

### DESCRIPTION

This disclosure, its aspects and implementations, are not limited to the specific components, frequency examples, or methods disclosed herein. Many additional components and assembly procedures known in the art consistent with embedding meta-data techniques that are in use with particular implementations will become apparent from this disclosure. Accordingly, for example, although particular implementations are disclosed, such implementations and implementing components may comprise any components, models, versions, quantities, and/or the like as is known in the art for such systems and implementing components, consistent with the intended operation.

This disclosure relates to a method of embedding information regarding an electromagnetic transmission's origin. The ability to provide information about a carrier signal's source that may include information about the transmission equipment (model, serial number, configuration, etc.), location (address, latitude and/or longitude), contact information, type of carrier, target or proposed destination, or any other relevant information. Implementations of the methods disclosed herein can be employed for an electromagnetic emitting device such as, for example, optical, Intermediate Frequency (IF) or Radio Frequency (RF) transmission equipment for point-to-point, point-to-multipoint and/or multipoint-to-multipoint embedded information. Additional details regarding and methods and systems relating to embedding information regarding an electromagnetic transmission's origin is disclosed in related U.S. Application 13/024,402 to Beeler et al. titled “Embedded Meta-Carrier with Spread Spectrum via Overlaid Carriers,” the disclosure of which was previously incorporated herein by reference.

For the implementations of the methods disclosed, data within the dummy-PL frame of a DVB-S2 transmission could be replaced with a modified XFECFRAME containing meta-data such as telemetry or coordinates (latitude and longitude manually entered or automatically provided by a Global Positioning System (GPS)). Other types of user data may include, but are not limited to, basic embedded management and control for passing terminal status or commands between two piers in a point to point link, antenna handover control messages, provisions for key management for TRANSEC applications, communication channel for dynamic bandwidth allocation system in point-to-point or point-to-multipoint links, or provisions for distribution of burst maps and allocations in burst systems. In the current art, a DVB-S2 modulating device may control the rate at which opportunities for transmitting baseband frames may occur. Therefore, using the teachings included in this disclosure, one may implement any embodiment of the described methods in a manner that periodically interrupts normal transmission to replace data within a dummy-PL frame with a modified XFECFRAME that contains meta-data. The insertion rate of modified XFECFRAME frames carrying meta-data may coincide with the natural insertion rate of required dummy-PL frames or may be artificially inserted after a pre-configured rate by a user of the described methods. In addition, a modulating device may insert meta-data to be scrambled and modulated by the DVB-S2 modulating device. The insertion rate of the meta-data into the modified pilot blocks carrying meta-data would coincide with the natural insertion rate of required pilot blocks as outlined in the described methods when pilot blocks are enabled.

For all modes of operation, Constant Coding and Modulation (“CCM”), Variable Coding and Modulation (“VCM”) and Adaptive Coding and Modulation (“ACM”), there may be a provision for use of a pilot sequence. The pilot sequence, if enabled, may be output every 16 slots of the XFECFRAME contained in the PL frame, unless the pilot block's position coincides with the beginning of the next Start of Frame (SOF) then the pilot block may not be transmitted. Conventionally, if the pilot block is transmitted, it comprises a series of 36 unmodulated symbols that exist in physical (PL) frame that is transmitted by the DVB-S2 modulating device.

This disclosure relates to, but is not limited to, improved embedding of the meta-data information techniques into a DVB-S2 stream. As an alternative embodiment, the meta-data information could be comprised of telemetry, coordinate (latitude and longitude manually entered or provided by a Global Positioning System (GPS) automatically), user data, etc. Particular implementations described herein are and may use, but are not limited to a dedicated interface for use by Field Programmable Gate Arrays (FPGA), Programmable Logic Devices (PLD), Programmable Integrated Circuits (PIC), digital signal processors, Application Specific Integrated Circuits (ASIC) or microprocessors using conventional implementation methods known in the art with knowledge of this disclosure.

Particular implementations assume that the initial configuration of the DVB-S2 modulating device may be known and properly configured, but as described in relation to particular implementations in this disclosure, the meta-data may be statically entered by the user directly into the modulating device or injected via an external physical/electrical interface.

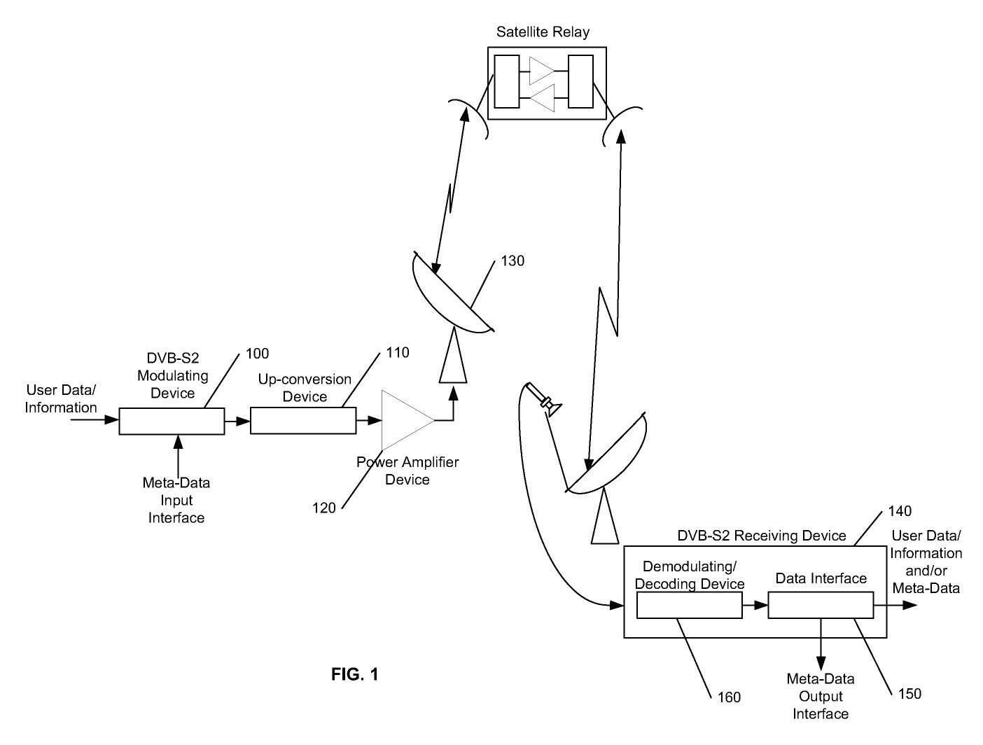

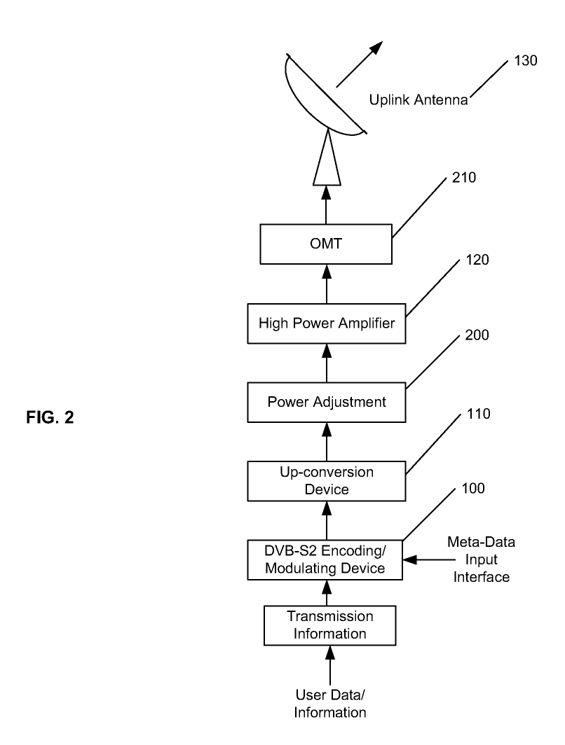

Particular implementations may operate on either a configuration that comprises VCM and/or ACM and utilizes the modified XFECFRAME frame in place of a dummy-PL frame for the transfer of meta-data or a configuration that comprises CCM, VCM and/or ACM and utilizes the pilot block for the transfer of the meta-data. The embedding of the meta-data may operate as information input from an external source as shown in FIGS. 1-2 or directly entered by the user, so the received meta-pilot carrier signal (original carrier and the embedded meta-data via modified XFECFRAME frames and/or pilot blocks) may employ digital signal processing (DSP) techniques, which may be easily implemented in FPGA, ASIC, digital signal processors, or microprocessors using conventional implementation methods known in the art with knowledge of this disclosure.

Aspects of this disclosure relate to a method and system for creating a meta-pilot carrier signal containing both meta-data and user data/information for transmission, and reception, demodulation, decoding and processing of the meta-data and the original desired user data/information. In another aspect, this disclosure relates to a method for providing for a standalone or redundant product where multiple redundant configurations may exist for ensuring reliable operation.

Particular implementations of insertion of meta-data into a DVB-S2 stream by a modulating device disclosed herein may be specifically employed in satellite communications systems. However, as will be clear to those of ordinary skill in the art from this disclosure, the principles and aspects disclosed herein may readily be applied to any electromagnetic (IF, RF and optical) communications system, such as terrestrial broadcast network without undue experimentation.

FIG. 1 illustrates a particular embodiment of a satellite network that comprises a satellite earth station where the transmission signal originates. User data/information may be input to the DVB-S2 modulating device 100 and may be combined with meta-data and the signal is then up-converted 110 and power amplified 120 for transmission by the uplink antenna 130.

FIG. 2 illustrates an implementation of transmission equipment at an earth station that is used for combining the user data/information with the meta-data in the DVB-S2 modulator 100. The user data/information may be in the form of, but is not limited to, data, video, audio, or voice data in an asynchronous or synchronous format. The modulated signal may then be output to an up-conversion device 110, power adjusted 200, power amplified 120, input to an orthogonal mode transducer (OMT) 210 for setting the proper EM polarization and transmitted by the uplink antenna 130.

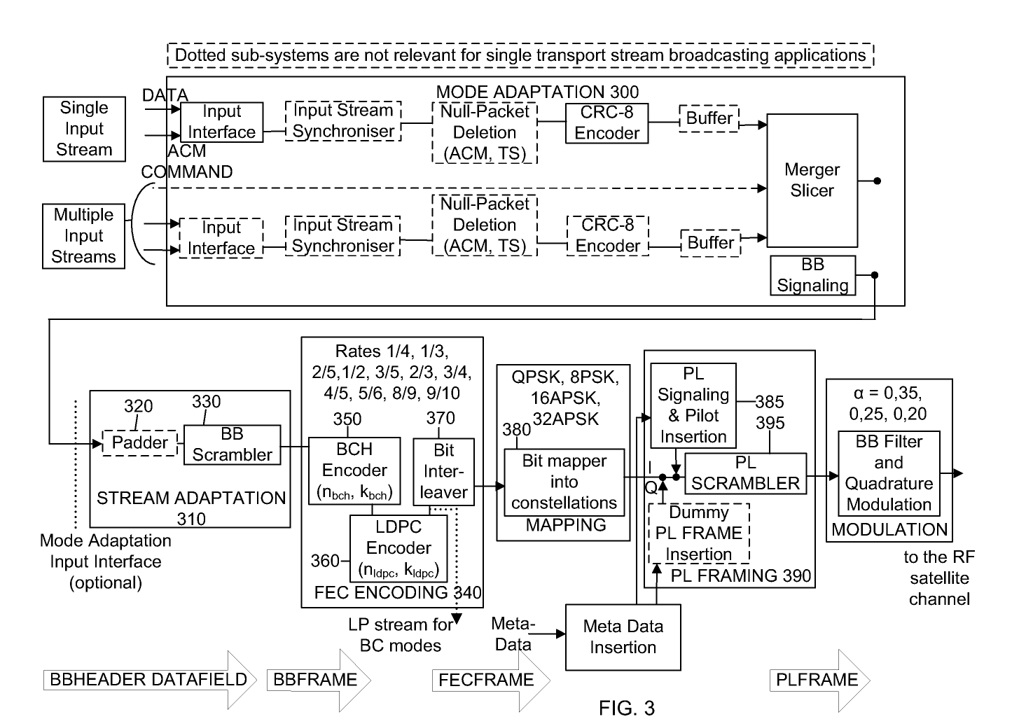

FIG. 3 illustrates a point at which meta-data information may be inserted by the modulating device 100. The only major change to the existing DVB-S2 modulation for use in conjunction with the methods described in this disclosure may be the addition of the meta-data as a replacement of the standard dummy-PL frames data with the modified PL frames, modified XFECFRAME frames, and the control of the insertion and replacement. For inserting the meta-data via the available pilots (when enabled), the rate of insertion and replacement of the unmodulated pilot block with the modified pilot block may be available any time the pilots are enabled. The meta-data insertion may be done at the PL Signaling & Pilot Insertion block 385 prior to PL scrambling 395. The meta-data inserted into the DVB-S2 stream as described in this method may not be FEC protected, and is subject to data corruption over the transmission link. Optionally, the user may choose to apply FEC protection to the meta-data as may be required in certain applications.

The transmission information may be received by devices currently used in the art such as a bridge, router, modem, etc. The user data/information may be interfaced to the DVB-S2 encoding/modulating device 100 as shown in FIG. 3. In a particular embodiment, the DVB-S2 modulating device 100 may be configured to provide DVB-S2 VCM or ACM. When operating with VCM or ACM, the mode adaptation module 300 may create baseband (BB) frames, and the stream may be provided to the Stream Adaptation Module 310. The Stream Adaptation Module 310 then may provide padding 320 and baseband scrambling 330 and may be output to the FEC encoder 340. The FEC encoder 340 then may apply both an outer code comprised of Bose-Chaudhuri-Hocquenghem (BCH) 350 and inner coding as Low-Density Party Checking (LDPC) 360, and then may bit interleave 370 the data to be output to the constellation mapper 380 for mapping to Quadrature-Phase Shift Keying (QPSK), 8-Phase Shift Keying (8-PSK), 16-Amplitude and Phase Shift Keying (16-APSK) or 32-Amplitude and Phase Shift Keying (32-APSK) modulation or 64-Amplitude and Phase Shift Keying though it is not described in the ETSI 302 307 specification. The output of the mapper may then be output to the PL-Framing module 390 where an implementation of the described method may be applied.

Conventionally, when the modulating device fails to receive a BB frame for transmission, the dummy-PL frame is generated to keep a constant stream of PL frames flowing. Since the modulating device may regulate the rate at which PL frames are sent using the described methods, the modulating device may purposefully and periodically generate a dummy-PL frame for use of the described methods. The presence of the dummy-PL frame may be detected and the “fill” information that is typically, but is not limited to, binary all zeros or ones, may be replaced with meta-data to form the modified XFECFRAME frame. The meta-data may be protected by a Cyclic-Redundancy Check (CRC), check-sum or FEC or any other appropriate technique. In a particular embodiment, a robust FEC may be added to the meta-data for both error checking and correcting meta-data as it traverses the system using the methods described herein.

When operating in CCM, VCM or ACM, pilot blocks may be enabled as a mechanism to assist in the demodulating device's ability to decoding the received signal. When pilot blocks are enabled, a pilot may be present every 16 slots and does not need to be transmitted unless the pilot block position coincides with the beginning of the next start of frame (SOF). The output of the DVB-S2 modulating device provides support for a waveform that may comprise an inner coding comprised of LDPC and an outer code of BCH coding and modulated to QPSK, 8-PSK, 16-APSK, 32-APSK or 64-APSK. The output of the modulator may be IF as 70/140 MHz (50 MHz to 180 MHz) or L-Band (950 MHz to 2,150 MHz), or RF. In a particular embodiment, the output of the modulating device may be IF and may be output to an up-conversion device. The up-conversion device may up-convert the IF to a common RF frequency in the L-Band, S-Band, C-Band, X-Band, Ku-Band or Ka-Band and may be power adjusted, high power amplified, directed to an OMT for proper polarization and output to an uplink antenna for transmission.

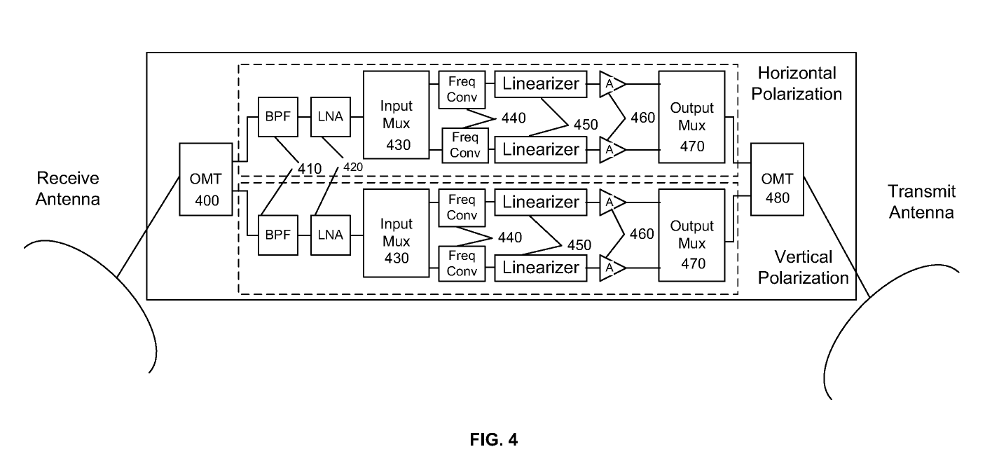

In a particular implementation, the transmission may be directed to an airborne or space-based satellite repeating relay as shown in FIG. 4. The input signal may be received at radio frequency (RF) and split to the proper polarization by on Orthogonal Mode Transducer (OMT) 400. The split signal may then be band-pass filtered (BPF) 410, amplified by a Low Noise Amplifier (LNA) 420, separated in frequency by an Input Multiplexer 430, frequency converted 440 up or down in frequency, linearized 450, amplified 460 and multiplexed 470 with other transponders and then combined by an OMT 480 to the proper polarization and transmitted by a transmit antenna from the relay to the receive location.

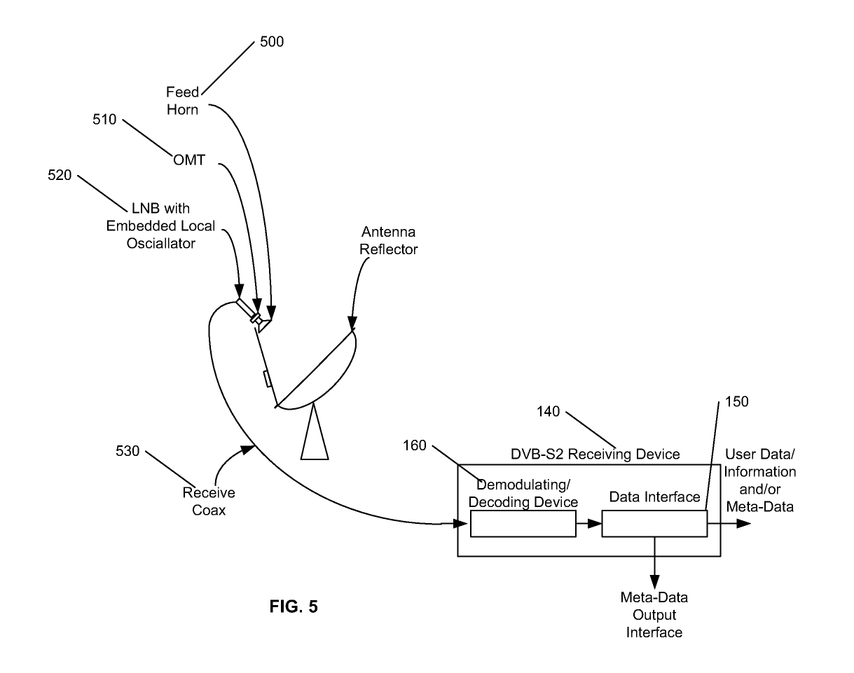

FIG. 5 illustrates a DVB-S2 remote satellite station where the RF signal may be received and focused to a feed horn 500 and separated to the proper EM polarization using an OMT 510. The signal may be then fed to a Low-Noise Block (LNB) module 520 that amplifies and down-converts the received RF to an IF as 70/140 MHz (50 MHz to 180 MHz) or L-Band (950 MHz to 2,150 MHz) to a coaxial connection 530 to the DVB-S2 receiving device 140. The receiving device 140 may then demodulate and decode 160 the transmission and process the signal using a data interface 150 that separates the meta-data to be output to a dedicated interface for use by a Field Programmable Gate Array (FPGA), Programmable Logic Device (PLD), Programmable Integrated Circuit (PIC), digital signal processor, Application Specific Integrated Circuit (ASIC), or microprocessor using conventional implementation methods known in the art with knowledge of this disclosure.

One implementation of a method for embedding information about the carrier is accomplished by exploiting and enhancing the physical framing structure of the Digital Video Broadcast-Satellite Second Generation (DVB-S2) standardized by the European Standards Telecommunications Institute (ETSI) and formally known as document number EN 302 307: “Digital Video Broadcasting (DVB); Second generation framing structure, channel coding and modulation system for Broadcasting, Interactive Services, News Gathering and other broadband satellite applications,” the disclosure of which is herein incorporated by reference in its entirety. The specification of EN 302 307 defines a plurality of configurations for coding and modulation known as CCM for constant rate transmission, VCM for an a priori configuration of coding and modulation rates, and ACM for adaptive (and dynamic) configurations of modulation and coding for interactive services. For CCM operation, conventional systems may include a mechanism for providing identification of services that are being carried by the CCM configuration that include Moving Picture Experts Group-2 (MPEG-2) transport streams (TS) that contain identification tables such as a Network Identification Table (NIT), a Program Association Table (PAT) and a Program Mapping Table (PMT) that are specified in the International Organization for Standards/International Electrotechnical Commission (ISO/IEC) standard 13818-1 for MPEG-2 transport streams.

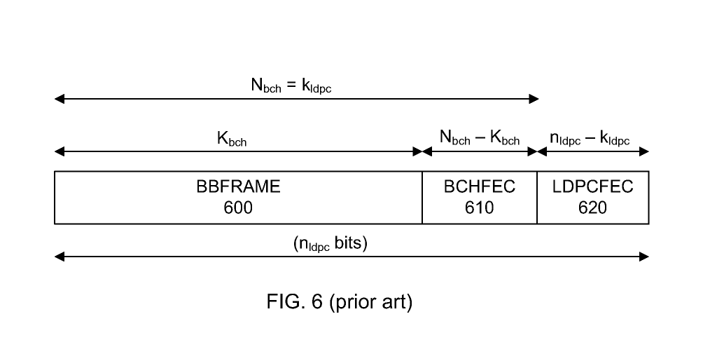

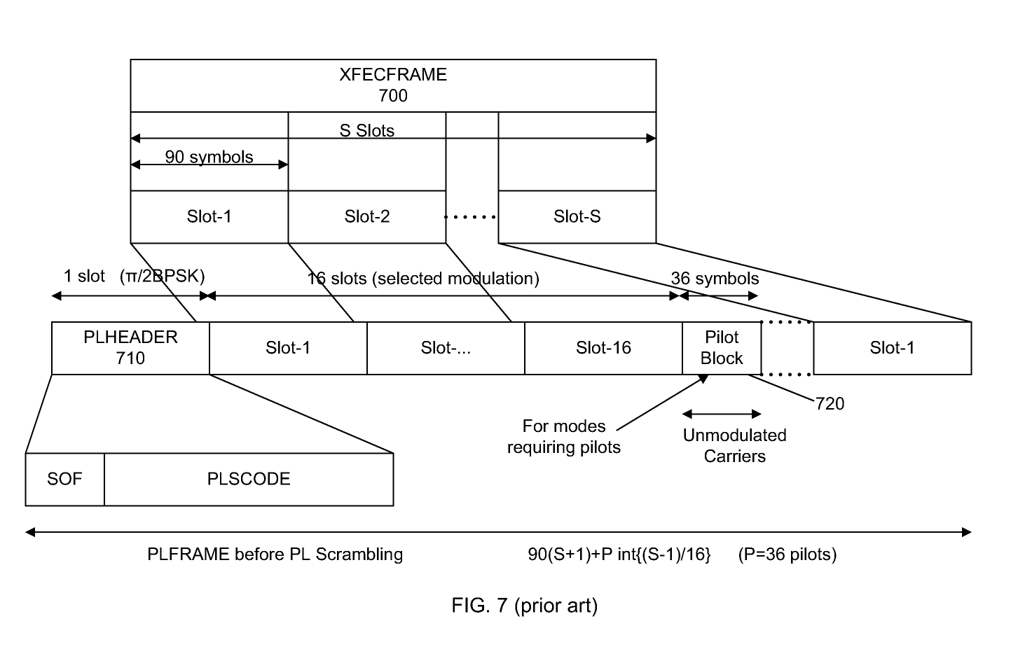

FIG. 6 illustrates the frame contents of a conventional, prior art PL frame as outlined in the ETSI EN 302 307 specification. More specifically, the data format prior to bit interleaving is depicted in FIG. 6 such that the outer coding (BCHFEC) 610 is appended after the base-band (BB) frame 600 and the inner coding (LDPCFEC) 620 is appended after the BCHFEC field 610. For VCM and ACM mode of operation, the standard differs in that an allocation is made for dummy-physical (PL) frames comprised of a PL header 710 and an XFECFRAME 700 as shown in FIGS. 6-7 to be generated by the modulating device when there is no useful data, in the form of a base-band (BB) frame 600 to be transmitted.

FIG. 7 illustrates the frame contents of the PL frame of FIG. 6 prior to PL Scrambling and the associated XFECFRAME frame 700 as outlined in the ETSI EN 302 307 specification as well as the placement of the pilot block 720 if enabled. In the absence of a BB frame 600 being available to be transmitted, the modulating device must output a physical frame known as a “dummy-physical frame” (dummy-PL frame). In the current art, the dummy-PL frame consists of 36 slots of unmodulated data and contains no useful or user information and operates in an unprotected format where there is no Forward Error Correction (FEC) protection on the content retained in the XFECFRAME 700.

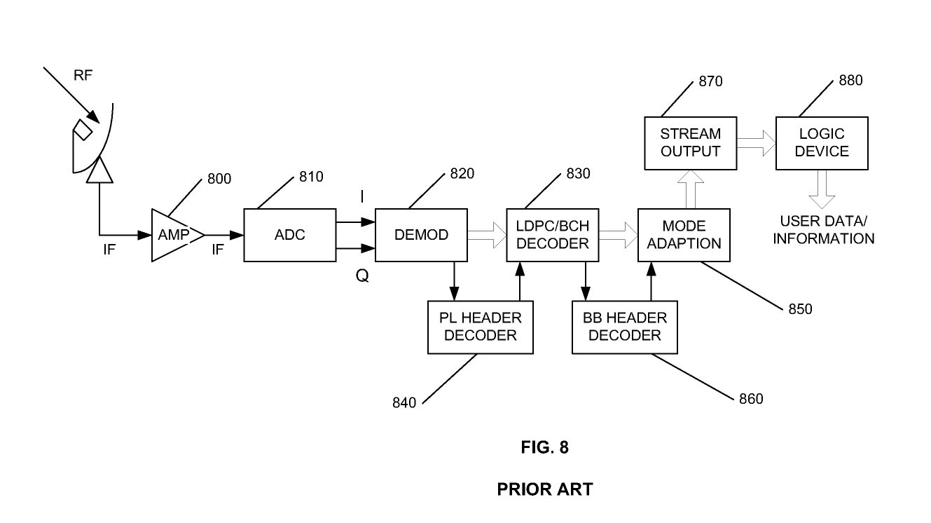

Currently, conventional systems comprise a DVB-S2 receiver that outputs user data/information, but does not output meta-data as shown in FIG. 8. In the receiver, the received IF signal may be amplified 800, sampled from an analog waveform to digital samples by an Analog to Digital Converter (ADC) 810 as an in-phase component known as “I” and quadrature component known as “Q.” The I/Q components may be fed to a demodulator 820 where the waveform may be de-rotated and demodulated to raw symbols. The output symbols from the demodulator may be fed to the LDPC/BCH decoder 830 and may be fed to the PL Header Decoder 840 for processing and the decoded information may be then fed to aid in the LDPC/BCH decoding 830 of the PL frames. The output of the BCH/LDPC decoder 830 may be fed to the Mode Adaptation Module 850 and BB Header Decoder 860 where the BB header information may be extracted and fed to the Mode Adaptation Module 850 for processing. The Mode Adaptation Module 850 then may process the appropriate delay and frame information and may then be fed to the stream output 870 for data formatting and output to the logic device 880 such as a Field Programmable Gate Arrays (FPGA), Programmable Logic Devices (PLD), Programmable Integrated Circuits (PIC), digital signal processors, Application Specific Integrated Circuits (ASIC) or microprocessors using conventional implementation methods known in the art with knowledge of this disclosure.

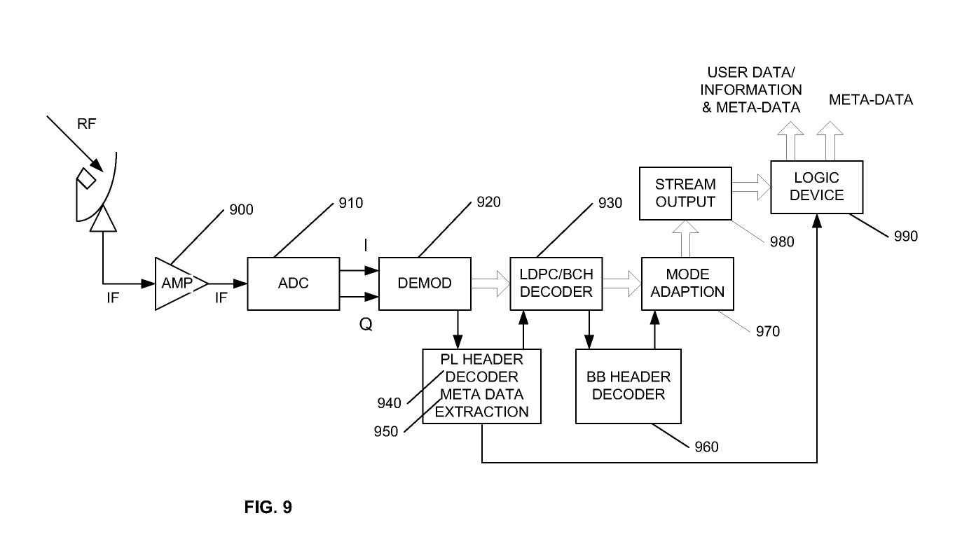

FIG. 9 illustrates an implementation of a DVB-S2 receiving device where the dummy-PL frames and/or the pilot blocks may be used for transferring meta-data to the receiving device. As shown, the received IF signal may be amplified 900, sampled from an analog waveform to digital samples by an Analog to Digital Converter (ADC) 910 as an in-phase component known as “I” and quadrature component known as “Q.” The I/Q components may be fed to a demodulator 920 where the waveform may be de-rotated and demodulated to raw symbols. The output symbols from the demodulator may be fed to the LDPC/BCH decoder 930 and may be fed to a PL Header Decoder 940 that has been modified to comprise not only the PL Header Decoder 940, but also a Meta Data Extraction Module 950. The Meta-data Extraction module may comprise a decoding device implemented as a Field Programmable Gate Array (FPGA), Programmable Logic Device (PLD), Programmable Integrated Circuit (PIC), digital signal processor, Application Specific Integrated Circuit (ASIC) or microprocessor using conventional implementation methods known in the art with knowledge of this disclosure for extracting either the dummy-PL frames and or pilot blocks if present in the data. The output of the demodulated data may be then fed directly to the logic device 990. In a particular embodiment, the logic device 990 may perform error checking and forward error correction to the data, but this is not a requirement of the described method. The logic device 990 may output the meta-data directly over a dedicated interface in raw bit or packetized format, combined with user data/information or displayed in a user viewable format directly on the DVB-S2 receive device. Alternatively, the output of the demodulated data from the PL Header Decoder 940 and Meta-Data Extraction Module 950 may be fed to the LDPC/BCH Decoder 930 and BB Header Decoder 960 where the BB header information may be extracted and fed to the Mode Adaptation Module 970 for processing. The Mode Adaptation Module 970 then may process the appropriate delay and frame information which may then be fed to the stream output 970 for data formatting and output to the logic device 990.

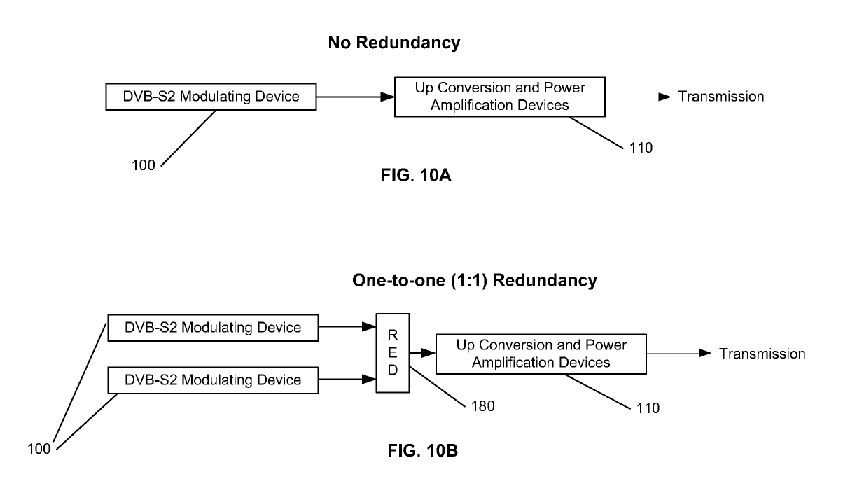

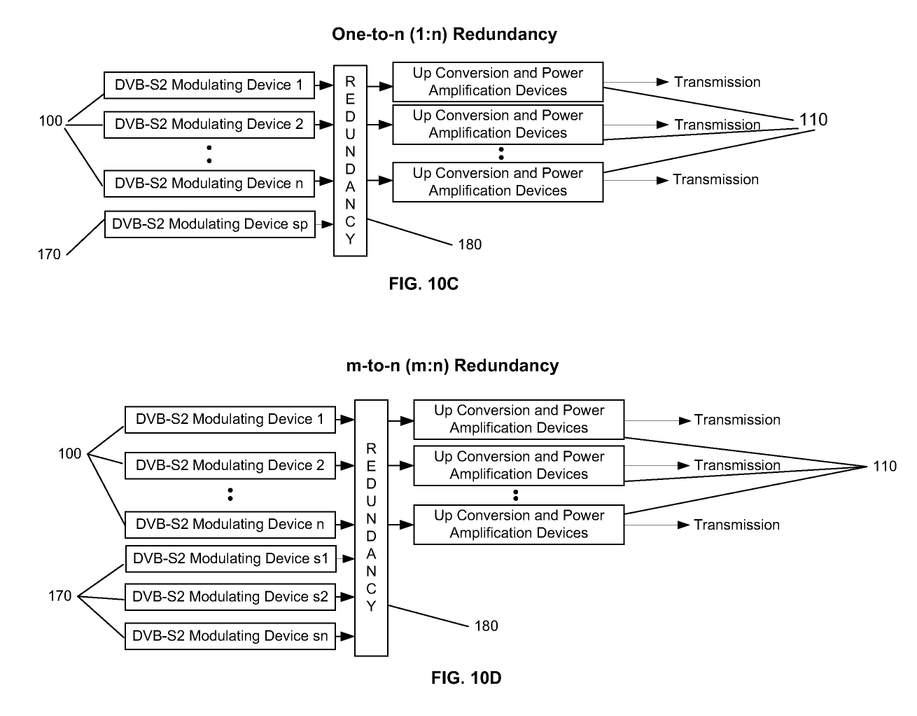

FIGS. 10A-D illustrate the operation of methods disclosed herein with consideration to redundancy for the direct embedding of the meta-data, and provide non-exhaustive case examples. As shown in FIG. 10A, no redundancy may be considered the most basic form of operation for transmission of the DVB-S2 user data/information with embedded the meta-data. The modulating device 100 may output the DVB-S2 signal with the meta-data embedded with the DVB-S2 modulation as outlined previously in FIG. 1. One-to-one (1:1) redundancy may accept the same output from the DVB-S2 modulating device100 and pass each output to an external redundancy device 180 as depicted in FIG. 10B. The concept of one-to-one provides a provision for a primary and a secondary unit. 1:1 redundancy may be accomplished either via an external redundancy device 180 or be contained into the DVB-S2 modulating/meta-data embedding device 100. As shown in FIG. 10C, one-to-n (1:n) redundancy accepts many inputs that are monitored by an external redundancy controller 180 for the appropriate routing to the up-conversion and power amplification 110. A single DVB-S2 modulating/meta-data embedding device 170 may provide backup to one-to-n online DVB-S2 modulating/meta-data embedding devices 100. M-to-n (m:n) redundancy, as depicted in FIG. 10D accepts many inputs that are monitored by an external redundancy controller 180 for routing to the appropriate up-conversion and power amplification 110. Multiple (m) DVB-S2 modulating/meta-data embedding device units 170 may provide backup to n online DVB-S2 modulating/meta-data embedding devices 100.

The meta-data information transmitted using the methods described in this disclosure may be finite and may require minimal bandwidth for delivery. This meta-data information may include, but is not limited to device manufacturer, device configuration, carrier frequency (configured and/or externally provided), symbol rate (configured and/or externally provided), location (detected via a GPS receiver, configured and/or externally provided), target destination (configured and/or externally provided), transmitter point of contact (configured and/or externally provided), transmitter contact information (configured and/or externally provided), or any other relevant information that is known to one of ordinary skill in the art.

The following are particular implementations of DVB-S2 modulating/meta-data embedding techniques provided as non-limiting examples:

### Example 1

A satellite earth station is configured to operate at an assigned center frequency, symbol rate and polarization to a satellite at a geo-equatorial location, polarization and frequency. For this example, the earth station is not pointed to the proper satellite and begins transmission. This results in the wrong satellite being illuminated. In the event the improperly radiated satellite has the frequency assigned for use that is not for this carrier signal, the result is an outage due to energy being injected into the satellite's transponder that is then re-transmitted along with the proper carrier to receiving devices. The methods disclosed herein may allow one to detect, resolve and process the interfering carrier's meta-data, thus providing information about the improperly configured carrier.

### Example 2

In particular implementations of the system described in Example 1, a carrier is uplinked to as part of an ad-hoc service, and the service is only required for a short duration. As an aid to the link provider, the transmission with meta-data may be used as confirmation of the transmission's origin and that the link is properly set up, which can be confirmed by a remote receiving station.

### Example 3

In particular implementations of the system described in Example 1, an earth station is configured to transmit a carrier at an assigned center frequency, symbol rate and polarization to a satellite at a particular frequency and geo-equatorial location. For this example, if the earth station is pointed to the proper satellite but has an incorrect carrier signal center frequency, and begins transmission, this results in the wrong frequency of a satellite transponder being illuminated. In this event, the improperly radiated satellite transponder has the frequency assigned for use, however, this transponder is not intended for this carrier signal. The result may be an outage due to energy being injected into the satellite's transponder that may be then re-transmitted along with the proper carrier. The methods disclosed herein may allow one to detect, resolve and process the interfering carrier's meta-data, thus providing information about the improperly configured carrier.

### Example 4

In particular implementations of the system described in Example 1, an earth station is configured to transmit a carrier at an assigned center frequency, symbol rate and polarization to a satellite at a particular frequency and geo-equatorial location. For this example, if the earth station is pointed to the proper satellite but has an incorrect carrier signal center frequency and begins transmission, this results in the wrong frequency of a satellite transponder being illuminated. In this event, the improperly radiated satellite transponder may not have the frequency assigned for use. The result may be a spurious carrier whose source may be difficult to identify. The methods disclosed herein may allow one to detect, resolve and process the interfering carrier's meta-data, thus providing information about the improperly configured carrier.

### Example 5

In particular implementations of the system described in Example 1, an earth station is configured to transmit a carrier at an assigned center frequency, symbol rate and polarization to a satellite at a particular frequency and geo-equatorial location. For this example, if the earth station is pointed to the proper satellite and has a correct carrier signal center frequency but a symbol rate that is in excess of the assigned symbol rate and begins transmission, this results in the satellite transponder being illuminated with a carrier that crosses over into an adjacent channel. In this event, the improperly radiated satellite transponder has multiple carriers using the same frequency. The result may be an outage potentially of both adjacent carriers due to energy being injected into the satellite's transponder that may be then re-transmitted along with the adjacent carrier. The methods disclosed herein may allow one to detect, resolve and process the interfering carrier's meta-data, thus providing information about the improperly configured carrier.

### Example 6

In particular implementations of the system described in Example 1, an earth station is configured to transmit a carrier at an assigned center frequency, symbol rate and polarization to a satellite at a particular frequency and geo-equatorial location. For this example, if the earth station is pointed to the proper satellite, has a correct carrier signal center frequency, but an incorrect polarization, and begins transmission, this may result in the wrong frequency of a satellite transponder being illuminated. In this event, the improperly radiated satellite transponder may have the frequency assigned for use, but not for the illuminated carrier. The result may be an outage due to energy being injected into the satellite's transponder that may be then re-transmitted along with the proper carrier. The methods disclosed herein may allow one to determine the interfering carrier's meta-data, thus providing information about the improperly configured carrier.

### Example 7

In particular implementations of the system described in Example 1, an earth station is configured to transmit a carrier at an assigned center frequency, symbol rate and polarization to a satellite at a particular frequency and geo-equatorial location. For this example, if the earth station is pointed to the proper satellite, has a correct carrier signal center frequency, but an incorrect polarization, and begins transmission, this may result in the wrong frequency of a satellite transponder being illuminated. In this event, the improperly radiated satellite transponder may not have the frequency assigned for use. The result may be a spurious carrier whose source may be difficult to identify. The methods disclosed herein may allow one to determine the interfering carrier's meta-data, thus providing information about the improperly configured carrier.

### Example 8

In particular implementations of system described in Example 1, a VCM carrier is configured to transmit from an earth station over a satellite link. The modulating device is configured to send a dummy-PL frame every five seconds for delivery of the meta-data. A receiving device using the methods disclosed herein may decode the meta-data for identification of the transmission source.

### Example 9

In particular implementations of system described in Example 1, an ACM carrier is configured to transmit from an earth station over a satellite link. The modulating device is configured to send a dummy-PL frame every five seconds for delivery of the meta-data. A receiving device using the methods disclosed herein may decode the meta-data for identification of the transmission source.

### Example 10

In particular implementations of system described in Example 1, a CCM carrier using pilots is configured to transmit from an earth station over a satellite link. The modulating device is configured to send a portion of the meta-data on every available opportunity so that a pilot block is available for transmission of meta-data. A receiving device using the methods disclosed herein may decode the meta-data for identification of the transmission source.

### Example 11

In particular implementations of system described in Example 1, a VCM carrier using pilots is configured to transmit from an earth station over a satellite link. The modulating device is configured to send a portion of the meta-data on every available opportunity so that a pilot block is available for transmission of meta-data. A receiving device using the methods disclosed herein may decode the meta-data for identification of the transmission source.

### Example 12

In particular implementations of system described in Example 1, an ACM carrier using pilots is configured to transmit from an earth station over a satellite link. The modulating device is configured to send a portion of the meta-data on every available opportunity so that a pilot block is available for transmission of meta-data. A receiving device using the methods disclosed herein may decode the meta-data for identification of the transmission source.

In places where the description above refers to particular implementations of to telecommunication systems and techniques for transmitting data across a telecommunication channel, it should be readily apparent that a number of modifications may be made without departing from the spirit thereof and that these implementations may be applied to other to telecommunication systems and techniques for transmitting data across a telecommunication channel.

1. A method of inserting meta-data into a physical layer framing structure of a Digital Video Broadcast Satellite-Generation 2 (DVB-S2), the method comprising:
encoding meta-data and an original carrier signal using an encoder, the original carrier signal having a pilot sequence;
replacing, by a meta-data insertion device, at least a portion of the pilot sequence with at least a portion of the meta-data to form a meta-pilot carrier signal;
modulating, using a modulator, the meta-pilot carrier signal to form a modulated meta-pilot carrier signal; and
transmitting, using a transmitting device, the modulated meta-pilot carrier signal.

2. The method of claim 1, further comprising determining whether pilots are enabled for a DVB-S2 prior to the replacing.

3. The method of claim 1, wherein the pilot sequence comprises 36 symbols and occurs every 16 slots in the original carrier signal.

4. The method of claim 3, wherein the symbols are defined as I=1/√2 and Q=1/√2.

5. The method of claim 1, wherein the meta-data comprises information relating to at least one of a manufacturer, a serial number, a model number, a configuration, and an operating parameter of a transmitting device.

6. The method of claim 1, further comprising encoding the meta-data using a Forward Error Correction (FEC) encoder.

7. The method of claim 4, further comprising randomization scrambling of the modulated I and Q symbols after bit mapping of the symbols into constellations after replacing.

8. The method of claim 1, further comprising receiving the meta-data from a user input.

9. The method of claim 1, wherein replacing the at least a portion of the pilot sequence comprises replacing using one of an internal processing device and an external processing device.

10. The method of claim 1, further comprising determining the meta-data based on a configuration of the transmitting device and incorporating the meta-data insertion device in the modulator.

11. The method of claim 1, wherein replacing further comprises replacing in a physical framing module within the modulator.

12. The method of claim 1, further comprising creating a redundancy of the meta-pilot carrier signal using a redundancy controller.

13. The method of claim 12, wherein the redundancy is a one-to-one redundancy or an m-to n redundancy.

14. A method of inserting meta-data into a physical layer framing structure of a Digital Video Broadcast Satellite-Generation 2 (DVB-S2), the method comprising:
encoding meta-data and an original carrier signal using an encoder,
determining whether a dummy XFECFRAME is required to be transmitted;
replacing, by a meta-data insertion device, 36 unmodulated slots of data within the encoded original carrier signal when no dummy XFECFRAME is required to be transmitted to form a meta-XFECFRAME carrier signal;
modulating, using a modulator, the meta-XFECFRAME carrier signal to form a modulated meta-XFECFRAME carrier signal; and
transmitting, using a transmitting device, the modulated meta-XFECFRAME carrier signal.

15. The method of claim 14, wherein the encoding and modulating comprises encoding and modulating using Adaptive Coding and Modulation (ACM).

16. The method of claim 14, wherein the encoding and modulating comprises encoding and modulating using Variable Coding and Modulation (VCM).

17. The method of claim 14, wherein the meta-data comprises information relating to at least one of a manufacturer, a serial number, a model number, a configuration, and an operating parameter of a transmitting device.

18. The method of claim 14, wherein the replacing further comprises injecting, by a meta-data insertion device, the meta-data into the dummy XFECFRAME prior to randomization scrambling of modulated I and Q symbols within the encoded original carrier signal and after bit mapping the symbols into constellations.

19. The method of claim 14, further comprising receiving the meta-data from a user input.

20. The method of claim 14, replacing the unmodulated slots of data further comprises replacing using one of an internal processing device and an external processing device.

21. The method of claim 14, further comprising determining the meta-data based on a configuration of the transmitting device and incorporating the meta-data insertion device in the modulator.

22. The method of claim 14, wherein replacing comprises replacing within a physical framing module in the modulator.

23. The method of claim 14, further comprising creating a redundancy of the meta-XFECFRAME carrier signal using a redundancy controller.

24. The method of claim 23, wherein the redundancy is a one-to-one redundancy or an m-to-n redundancy.

25. A method of extracting meta-data from a physical layer framing structure of a Digital Video Broadcast Satellite-Generation 2 (DVB-S2) by a receiving device, the method comprising:
receiving, by a receiving device, a meta-pilot carrier signal comprising meta-data and an original carrier signal;
demodulating, using a demodulator, the meta-pilot carrier signal;
decoding, using a decoder, the meta-pilot carrier signal; and
extracting, using an extraction device, meta-data embedded within a pilot sequence of the original carrier signal upon recognition of a physical layer frame when the pilot sequence is enabled.

26. The method of claim 25, wherein the pilot sequence is extracted by the demodulator.

27. The method of claim 25, wherein the extraction device is a physical layer header decoder and extracts a header of the original carrier signal.

28. The method of claim 25, further comprising processing the meta-data when Forward Error Correction (FEC) is present using a FEC decoder.

29. The method of claim 25, further comprising outputting the meta-data to a receiving device.

30. The method of claim 25, further comprising outputting the meta-data to a display device.

31. The method of claim 25, further comprising outputting the meta-data to a computing device.

32. A method of extracting meta-data from a physical layer framing structure of a Digital Video Broadcast Satellite-Generation 2 (DVB-S2) by a receiving device, the method comprising:
receiving, by a receiving device, a meta-pilot carrier signal comprising meta-data and an original carrier signal;
demodulating, using a demodulator, the meta-pilot carrier signal;
decoding, using a decoder, the meta-pilot carrier signal; and
extracting, using an extraction device, meta-data embedded within the original carrier signal upon recognition of a dummy physical layer frame, the meta-data having previously replaced unmodulated slots of data within the original carrier signal prior to transmission of the original carrier signal to the receiving device.

33. The method of claim 32, wherein the demodulator extracts meta-data contained in a dummy XFECFRAME.

34. The method of claim 32, wherein the extraction device is a physical layer header decoder.

35. The method of claim 32, further comprising processing a dummy physical layer frame using Adaptive Coding and Modulation (ACM) or Variable Coding and Modulation (VCM).

36. The method of claim 32, further comprising processing the meta-data when Forward Error Correction (FEC) is present using a FEC encoder.

37. The method of claim 32, further comprising, outputting the meta-data to a receiving device.

38. The method of claim 32, further comprising outputting the meta-data to a display device.

39. The method of claim 32, further comprising outputting the meta-data to a computing device.

40. A system for inserting meta-data into a physical layer framing structure of a Digital Video Broadcast Satellite-Generation 2 (DVB-S2), the system comprising:
an encoder configured to encode meta-data and an original carrier signal, the original carrier signal having a pilot sequence;
a meta-data insertion device configured to replace at least a portion of the pilot sequence with at least a portion of the meta-data to form a meta-pilot carrier signal;
a modulator configured to modulate the meta-pilot carrier signal to form a modulated meta-pilot carrier signal; and
a transmitting device configured to transmit the modulated meta-pilot carrier signal.

41. The system of claim 40, wherein the meta-data insertion device is configured to determine whether pilots are enabled for a DVB-S2 prior to replacing the at least a portion of the pilot sequence.

42. The method of claim 40, wherein the pilot sequence comprises 36 symbols and occurs every 16 slots in the original carrier signal.

43. The system of claim 42, wherein the symbols are defined as I=1/√2 and Q=1/√2.

44. The system of claim 40, wherein the meta-data comprises information relating to at least one of a manufacturer, serial number, model number, configuration, and an operating parameter of a transmitting device.

45. The system of claim 40, further comprising a Forward Error Correction (FEC) encoder that encodes the meta-data.

46. The system of claim 43, further comprising:
a bit mapper configured to map the I and Q symbols into constellations prior to replacement of the at least a portion of the pilot sequence; and
a scrambler configured to randomly scramble the modulated I and Q symbols after the at least a portion of the pilot sequence is replaced.

47. The system of claim 40, wherein the encoder is configured to receive the meta-data through a user input.

48. The system of claim 40, further comprising a processing device configured to replace the at least a portion of the pilot sequence with the at least a portion of the meta-data.

49. The system of claim 40, wherein the modulator is configured to insert the meta-data into the pilot sequence of the original carrier after a determination of the meta-data based on the configuration of the transmitting device.

50. The system of claim 40, wherein the modulator further comprises a physical framing module configured to replace the at least a portion of the pilot sequence with the at least a portion of the meta-data.

51. The system of claim 40, further comprising redundancy controller configured to create a redundancy of the meta-pilot carrier signal.

52. The system of claim 51, wherein the redundancy is a one-to-one redundancy or an m-to-n redundancy.

53. A system for inserting meta-data into a physical layer framing structure of a Digital Video Broadcast Satellite-Generation 2 (DVB-S2), the system comprising:
an encoder configured to encode meta-data and an original carrier signal;
a meta-data insertion device configured to determine whether an XFECFRAME is required to be transmitted and to replace 36 unmodulated slots of data within the encoded original carrier signal with at least a portion of the meta-data when no XFECFRAME is required to be transmitted to form a meta-pilot carrier signal;
a modulator configured to modulate the meta-pilot carrier signal to form a modulated meta-pilot carrier signal; and
a transmitting device configured to transmit the modulated meta-pilot carrier signal.

54. The system of claim 53, wherein the encoder and modulator are configured to use an Adaptive Coding and Modulation (ACM) format.

55. The system of claim 53, wherein the encoder and modulator are configured to use a Variable Coding and Modulation (VCM) format.

56. The system of claim 53, wherein the meta-data comprises information relating to at least one of a manufacturer, serial number, model number, configuration, and an operating parameter of a transmitting device.

57. The system of claim 53, further comprising:
a bit mapper configured to map I and Q symbols within the encoded original carrier signal into constellations prior to replacement of the at least a portion of the pilot sequence; and
a scrambler configured to randomly scramble the modulated I and Q symbols after the at least a portion of the meta-data is injected into a dummy physical layer frame.

58. The system of claim 53, wherein the encoder is configured to receive the meta-data from a user input.

59. The system of claim 53, further comprising a processing device configured to inject the meta-data.

60. The system of claim 53, wherein the meta-data is determined based on the configuration of the transmitting device and wherein the modulator is configured to replace the 36 unmodulated slots with the meta-data.

61. The system of claim 53, wherein the modulator further comprises a physical framing module configured to replace the unmodulated slots of data.

62. The system of claim 53, further comprising a redundancy controller configured to create a redundancy of the meta-pilot carrier signal.

63. The system of claim 62, wherein the redundancy is a one-to-one redundancy or an m-to-n redundancy.

64. A system for extracting meta-data from a physical layer framing structure of a Digital Video Broadcast Satellite-Generation 2 (DVB-S2) by a receiving device, the system comprising:
a receiving device configured to receive a meta-pilot carrier signal comprising meta-data and an original carrier signal;
a demodulator configured to demodulate the meta-pilot carrier signal;
a decoder that decodes the meta-pilot carrier signal; and
an extraction device configured to extract meta-data embedded within a pilot sequence of the original carrier signal upon recognition of a physical layer frame when the pilot sequence is enabled.

65. The system of claim 64, wherein the demodulator is further configured to extract the pilot sequence.

66. The system of claim 64, wherein the extraction device is a physical layer header decoder and is configured to extract a header of the original carrier signal.

67. The system of claim 64, wherein the meta-data is processed when Forward Error Correction (FEC) is present.

68. The system of claim 64, further comprising a receiving device configured to receive an output of the meta-data.

69. The system of claim 64, further comprising a display device configured to receive an output of the meta-data.

70. The system of claim 64, further comprising a computing device configured to receive an output of the meta-data.

71. A system of extracting meta-data from a physical layer framing structure of a Digital Video Broadcast Satellite-Generation 2 (DVB-S2) by a receiving device, the system comprising:
a receiving device configured to receive a meta-pilot carrier signal comprising meta-data and an original carrier signal;
a demodulator configured to demodulate the meta-pilot carrier signal;
a decoder that decodes the meta-pilot carrier signal; and
an extraction device configured to extract meta-data embedded within the original carrier signal upon recognition of a dummy physical layer frame, the meta-data having previously replaced unmodulated slots of data within the original carrier signal prior to transmission of the original carrier signal to the receiving device.

72. The system of claim 71, wherein the demodulator is configured to extract meta-data contained in an XFECFRAME of a dummy physical layer frame.

73. The system of claim 71, wherein the extraction device is a physical layer header decoder.

74. The system of claim 71, further comprising a processor configured to processes a dummy physical layer frame using Adaptive Coding and Modulation (ACM) or Variable Coding and Modulation (VCM).

75. The system of claim 71, wherein the meta-data is processed when Forward Error Correction (FEC) is present.

76. The system of claim 71, further comprising a receiving device configured to receive an output of the meta-data.

77. The system of claim 71, further comprising a display device configured to receive an output of the meta-data.

78. The system of claim 71, further comprising a computing device configured to receive an output of the meta-data.
